(19) United States
(12) Patent Application Publication
(10) Pub. No.: US 2008/0201134 A1
(43) Pub. Date: Aug. 21, 2008

(54) COMPUTER-READABLE RECORD MEDIUM IN WHICH NAMED ENTITY EXTRACTION PROGRAM IS RECORDED, NAMED ENTITY EXTRACTION METHOD AND NAMED ENTITY EXTRACTION APPARATUS

(75) Inventors: Tomoya Iwakura, Kawasaki (JP); Seishi Okamoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/025,482

(22) Filed: Feb. 4, 2008

(30) Foreign Application Priority Data
Feb. 15, 2007 (JP) 2007-35434

(51) Int. Cl. G10L 11/06

(52) U.S. Cl. 704/10

(57) ABSTRACT

A named entity extraction apparatus includes an extraction result acquisition unit for acquiring a named entity extraction result obtained as a result of a named entity extraction process; and a lexicon information creation unit for creating lexicon information which is utilized as clues in extracting named entities from text data, on the basis of the named entity extraction result acquired by said extraction result acquisition unit.

### BACKGROUND OF THE INVENTION

1. Field of the Invention

This invention relates to named entity extraction processing which employs a model for extracting a named entity from text data automatically.

2. Description of the Related Art

Heretofore, there has been a technique wherein named entities (for example, proper nouns such as a person's name and a place, and numerical entities such as a date and an amount of money) are extracted from inputted text data (refer to JP-A-2002-183133). In addition, the related-art technique extracts the named entities from the text data on the basis of a named entity extraction model (rules) generated by employing a machine learning algorithm and learning data.

In the creation of the named entity extraction model, “lexicon information” is generally utilized as clues for extracting the named entities from the inputted text data. The “lexicon information” contains information items for obtaining such exemplary clues that a word “Miyazaki” may possibly be the “person's name” or the “place”, and that a “president” or “Mr./Ms.” is a word suggestive of the “person's name”.

The related-art technique, however, has had the problem that much labor is expended in creating lexicons which serve to obtain the clues for extracting the named entities from the text data. More specifically, the creation of the “lexicon information” has hitherto been made manually. Therefore, much labor is expended in creating the lexicons for the respective category candidates of the named entities (for example, the items of the “person's names”, such as “Miyazaki” and “Satoh”) for every word expected to be extracted from the text data.

Moreover, the manual creation of the lexicon information makes it difficult to cope with the alteration of the pattern (for example, language or context) of the text data supposed to be inputted, according to the circumstances.

It is therefore an object of this invention to easily create lexicon information for obtaining clues for extracting named entities from text data, without expending much labor.

### SUMMARY

According to an aspect of an embodiment, a named entity extraction apparatus generates lexicon information automatically. An extraction result acquisition unit acquires a named entity extraction result obtained as a result of a named entity extraction process. A lexicon information creation unit creates lexicon information which is utilized as clues in extracting named entities from text data, on the basis of the named entity extraction result acquired by the extraction result acquisition unit.

### BRIEF DESCRIPTION OF THE DRAWINGS

FIG. 1 is a diagram for explaining the outline and features of a named entity extraction apparatus according to Embodiment 1;

FIG. 2 is a diagram showing a structural example of lexicon information generated according to Embodiment 1;

FIG. 3 is a block diagram showing the configuration of the named entity extraction apparatus according to Embodiment 1;

FIG. 4 is a diagram showing a structural example of learning data according to Embodiment 1;

FIG. 5 is a diagram showing a structural example of an internal entity according to Embodiment 1;

FIG. 6 is a diagram showing setting examples of positional information on the positions of words within text data;

FIG. 7 is a flow chart showing the flow of the process of the named entity extraction apparatus according to Embodiment 1;

FIGS. 8A and 8B form a diagram for explaining the outline and features of a named entity extraction apparatus according to Embodiment 2;

FIG. 9 is a diagram showing a structural example of an NE extraction model according to Embodiment 2; and

FIG. 10 is a diagram showing a computer which runs a named entity extraction program.

### DETAILED DESCRIPTION OF THE EMBODIMENT

(Explanation of Terms)

First of all, the main terms for use in embodiments to be described below will be explained. An expression “NE” for use in the ensuing embodiments signifies a “named entity”, to which a proper noun or a numerical entity, for example, corresponds. In Embodiment 1 to be described below, there will be set predetermined NE classification candidates such as a “person's name” or a “place” for the proper noun, a “date” or an “amount of money” for the numerical entity, and “another” for any expression other than the proper noun and the numerical entity.

“Learning data” for use in the ensuing embodiment is exemplary data with a correct interpretation, and a “machine learning algorithm” is a technique in which a model (rules) for extracting the named entity from text data is automatically created from the learning data. Incidentally, the “exemplary data with a correct interpretation” is, for example, data which correctly interprets that a word “Yamada” is the “person's name”.

(Outline and Features of Named Entity Extraction Apparatus (Embodiment 1))

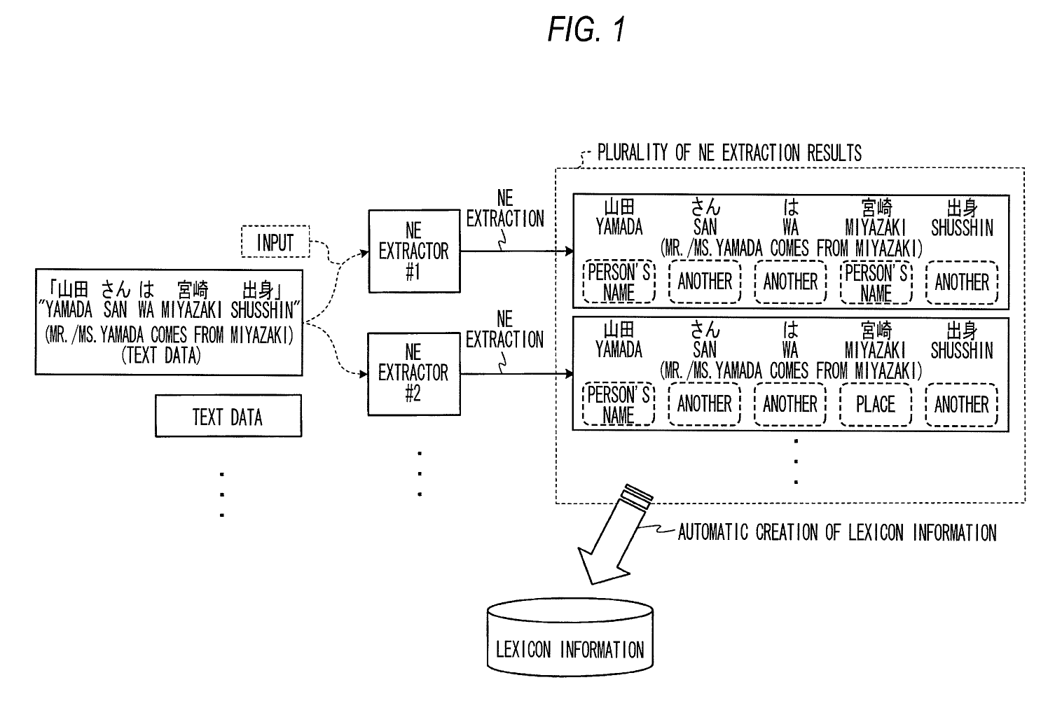

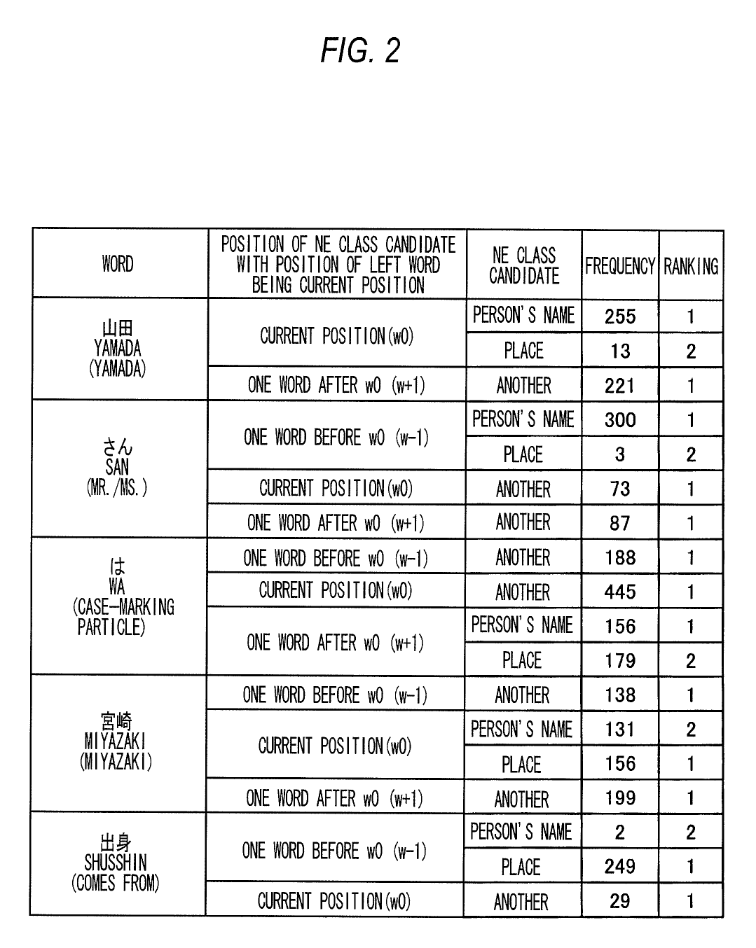

Next, the outline and features of a named entity extraction apparatus according to Embodiment 1 will be described with reference to FIGS. 1 and 2. FIG. 1 is a diagram for explaining the outline and features of the named entity extraction apparatus according to Embodiment 1, while FIG. 2 is a diagram showing a structural example of lexicon information according to Embodiment 1.

The named entity extraction apparatus according to Embodiment 1 is outlined as executing a named entity extraction process (NE extraction process) which employs a model for extracting a named entity (NE) from text data. This extraction apparatus, however, has its principal feature in that the lexicon information which serves to obtain a clue for extracting the named entity from the text data can be easily created without expending much labor.

As shown in FIG. 1, the named entity extraction apparatus according to Embodiment 1 executes a plurality of NE extraction processes concerning the text data, by employing a plurality of NE extractors, thereby acquiring a plurality of NE extraction results. That is, the NE extraction processes are executed on all text data by employing the respective NE extractors (such as the NE extractor #1 and the NE extractor #2), and the NE extraction results which carry the labels of NE classification candidates (for example, labels indicating the NE classification candidates of a “person's name”, a “place”, etc.) are outputted as to respective words within the text data.

As shown in FIG. 1 by way of example, when the NE extraction process concerning the text data of “YAMADA SAN WA MIYAZAKI SHUSSHIN” (MR./MS. YAMADA COMES FROM MIYAZAKI) is executed by employing the NE extractor #1, there is outputted the NE extraction result in which the word “YAMADA” in the text data is endowed with the label of the NE classification candidate of the “person's name”, the word “SAN” with the NE classification candidate label of “another”, the word “WA” with the NE classification candidate label of “another”, the word “MIYAZAKI” with the NE classification candidate label of the “person's name”, and the word “SHUSSHIN” (COMES FROM) with the NE classification candidate label of “another”.

The named entity extraction apparatus according to Embodiment 1, automatically creates the lexicon information which serves to obtain clues for extracting the named entities from the text data, by using the plurality of NE extraction results acquired from the respective NE extractors.

With the named entity extraction apparatus according to Embodiment 1, as shown in FIG. 2, words are extracted from the plurality of NE extraction results without being repeated (for example, words “YAMADA” and “SAN” are extracted), and processing to be described below is executed in a sequence from, for example, the first extracted word.

First, the named entity extraction apparatus according to Embodiment 1 checks the individual NE extraction results in succession, so as to extract NE candidate classes. The individual NE extraction results are checked in succession, so as to extract the NE candidate class for, for example, the word extracted first from the individual NE extraction results and to extract the NE candidate classes located before and after the first extracted word as a current position.

By way of example, the named entity extraction apparatus according to Embodiment 1 extracts the NE candidate class (for example, the “person's name” or the “place”) as to “YAMADA” which is the word extracted first from the NE extraction results, and it extracts the NE candidate class (for example, the “another”) which is located one word (w+1) after the current position (w0) being the position of “YAMADA” (refer to FIG. 2).

After having extracted the NE candidate classes, the named entity extraction apparatus according to Embodiment 1 counts the frequencies of appearance of the NE candidate classes in the NE extraction results. By way of example, the extraction apparatus counts the number of times which the NE candidate class concerning “YAMADA” is outputted as the “person's name” or the “place”, in all the NE extraction results. In addition, it counts the number of times of appearance which the NE candidate class located one word (w+1) after the current position (w0) being the position of “YAMADA” is outputted as the “another” (refer to FIG. 2).

After having counted the frequencies of appearance, the named entity extraction apparatus according to Embodiment 1 determines the ranking of the NE candidate classes corresponding to the frequencies of appearance. In a case, for example, where the frequency of appearance at which the NE candidate class is outputted as the “person's name” as to “YAMADA” is “255” and where the frequency of appearance at which it is outputted as the “place” is “13”, the “person's name” is determined to be in the rank “1” (first rank), and the “place” is determined to be in the rank “2” (second rank). Incidentally, since only one NE candidate class located one word after “YAMADA” is extracted (only the “another” is extracted), the “another” is determined to be in the rank “1” (refer to FIG. 2).

In addition, the named entity extraction apparatus according to Embodiment 1 confirms whether or not the processing thus far described (the extraction of the NE candidate classes, the counting of the frequencies of appearance, and the determination of the ranks) has been executed as to all the words extracted from the NE extraction results. In a case where all the words have been processed as the result of the confirmation, the processing is ended. On the other hand, in a case where all the extracted words have not been processed as stated above, the processing is executed from the extraction of the NE candidate classes in succession for the respective remaining words. In a case, for example, where “YAMADA” has been processed, the processing is subsequently executed from the extraction of the NE candidate classes as to “SAN” (refer to FIG. 2).

In this manner, the named entity extraction apparatus according to Embodiment 1 can easily create the lexicon information which serves to obtain the clues for extracting the named entities from the text data, without expending much labor as in the principal feature stated before.

(Configuration of Named Entity Extraction Apparatus (Embodiment 1))

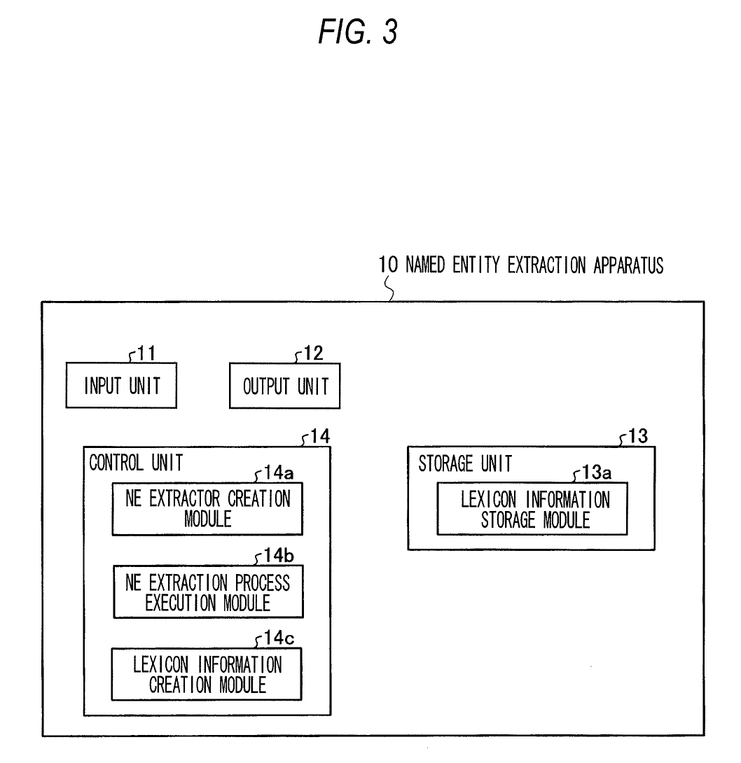

Next, the configuration of the named entity extraction apparatus according to Embodiment 1 will be described with reference to FIG. 3. FIG. 3 is a block diagram showing the configuration of the named entity extraction apparatus according to Embodiment 1.

As shown in the figure, the named entity extraction apparatus 10 according to Embodiment 1 is configured of an input unit 11, an output unit 12, a storage unit 13 and a control unit 14.

The input unit 11 is an input portion which accepts the inputs of various information items. It is configured including a keyboard, a mouse, a microphone, etc., and it accepts the inputs of, for example, text data. Incidentally, the input unit 11 may well be configured including a scanner or the like having a data read function, so as to accept the input of the text data read by the data read function of the scanner.

The output unit 12 is an output portion which outputs various information items. It can include a monitor (or a display, a touch panel) and a loudspeaker, and it displays and outputs, for example, an extraction result based on an NE extraction process execution module 14b to be explained later.

The storage unit 13 is a storage portion which stores therein data and programs necessary for various processes based on the control unit 14. It includes a lexicon information storage module 13a as being especially closely relevant to the invention. The lexicon information storage module 13a is configured by storing therein the lexicon information (refer to FIG. 2) which has been created by a lexicon information creation module 14c to be explained below.

The control unit 14 is a processing portion which includes an internal memory for storing therein the required data and the programs that stipulate predetermined control programs, various processing procedures, etc., and which executes the various processes with the programs and the data. This control unit 14 includes an NE extractor creation module 14a, the NE extraction process execution module 14b and the lexicon information creation module 14c.

The NE extractor creation module 14a is a processing portion which creates an NE extractor for executing an NE (named entity) extraction process from the text data.

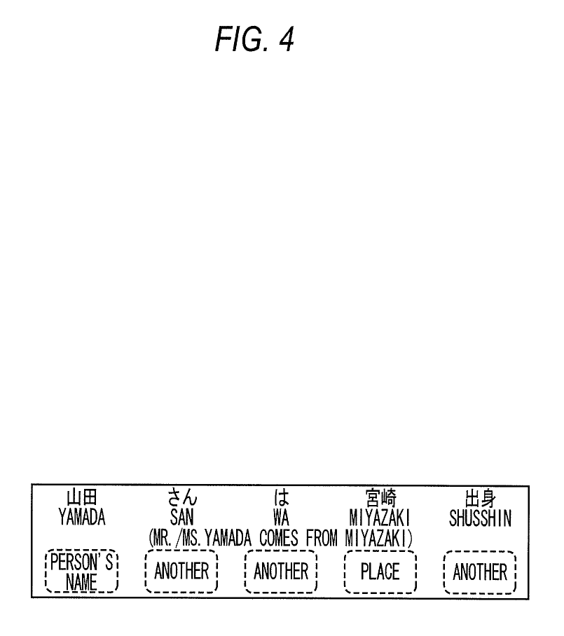

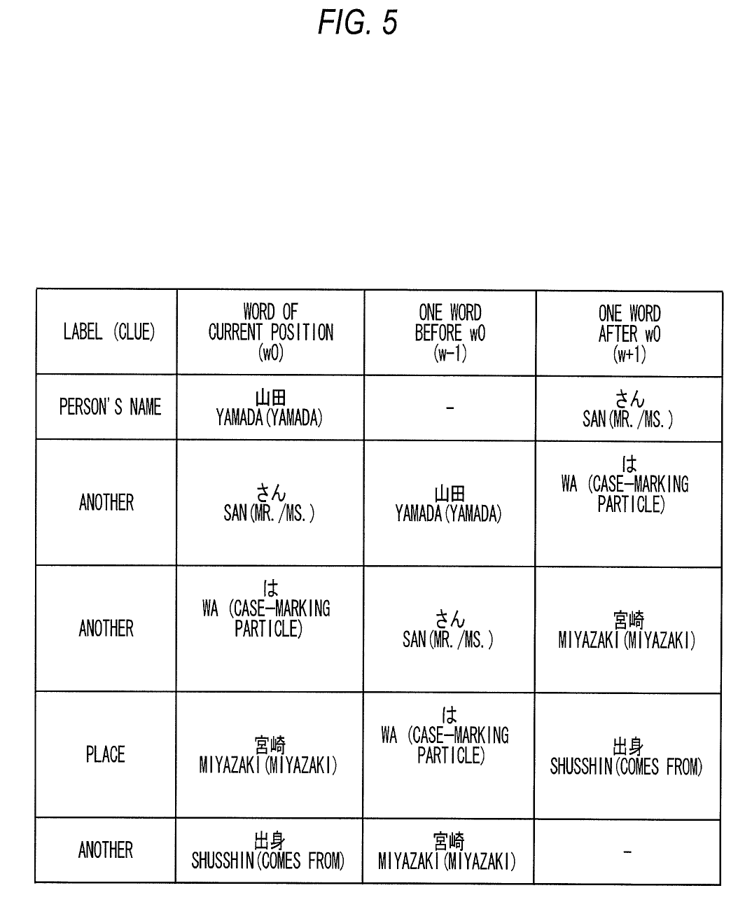

The NE extractor creation module 14a converts learning data (refer to, for example, FIG. 4) which is exemplary data with correct interpretation, into an internal entity (refer to, for example, FIG. 5) corresponding to a position within the data.

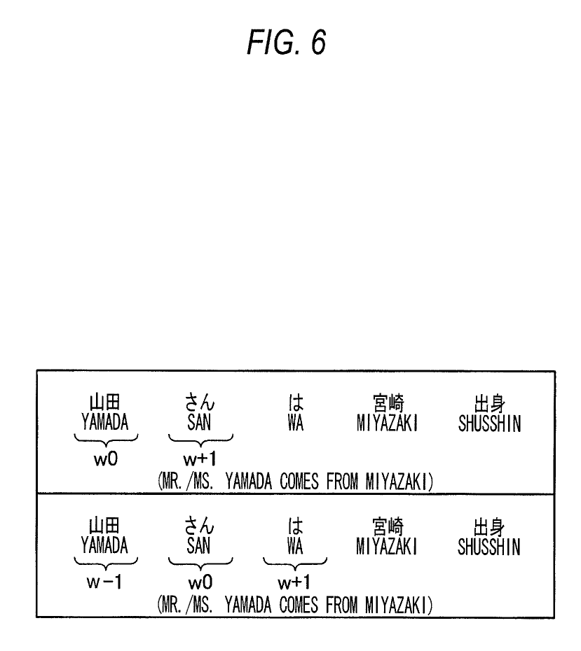

The NE extractor creation module 14a sets positional information (for example, information “w0” for a current position, or information “w+1” for a position being one word after the current position) within the internal entity, on the basis of the position within the text data, as exemplified in FIG. 6. In addition, the NE extractor creation module 14a analyzes the internal entity thus obtained, by applying this internal entity to a plurality of machine learning algorithms, thereby to create NE extraction models (rules) for extracting NEs from the text data, and it creates the respective NE extractors which operate the individual created NE extraction models.

The NE extraction process execution module 14b is a processing portion which executes the NE extraction process as to the inputted text data. Concretely, the NE extraction process execution module 14b executes the NE extraction processes for the respective text data items accepted from the input unit 11, by employing the corresponding NE extractors created by the NE extractor creation module 14a. In addition, this NE extraction process execution module 14b outputs to the lexicon information creation module 14c, NE extraction results which are endowed with the labels of NE classification candidates (for example, labels indicating the NE classification candidates of a “person's name”, a “place”, etc.) as to respective words within the text data.

As shown in FIG. 1 by way of example, when the NE extraction process concerning the text data of “YAMADA SAN WA MIYAZAKI SHUSSHIN” (MR./MS. YAMADA COMES FROM MIYAZAKI) is executed by employing the NE extractor #1, the NE extraction result in which the word “YAMADA” within the text data is endowed with the label of the NE classification candidate of the “person's name” is outputted. Likewise, the NE extraction result in which the word “SAN” is endowed with the NE classification candidate label of “another”, the word “WA” with the NE classification candidate label of the “another”, the word “MIYAZAKI” with the NE classification candidate label of the “person's name”, and the word “SHUSSHIN” with the NE classification candidate label of the “another” is outputted.

The lexicon information creation module 14c is a processing portion which automatically creates lexicon information for obtaining clues for extracting the named entities from the text data, by employing the plurality of NE extraction results acquired from the NE extraction process execution module 14b. Concretely, words are extracted (for example, the words “YAMADA” and “SAN”) from the plurality of NE extraction results without being repeated, and they are arrayed in the order of the extractions. In addition, the respective extracted words are subjected to processing as explained below, in a sequence from, for example, the word arrayed in the foremost place.

First, the lexicon information creation module 14c checks the respective NE extraction results in succession, so as to extract NE candidate classes. The individual NE extraction results are checked in succession, so as to extract the NE candidate class for, for example, the word extracted first from the individual NE extraction results and to extract the NE candidate classes located before and after the first extracted word as a current position.

By way of example, the lexicon information creation module 14c extracts the NE candidate class (for example, the “person's name” or the “place”) as to “YAMADA” which is the word extracted first from the NE extraction results, and it extracts the NE candidate class (for example, the “another”) which is located one word (w+1) after the current position (w0) being the position of “YAMADA” (refer to FIG. 2).

After having extracted the NE candidate classes, the lexicon information creation module 14c counts the frequencies of appearance of the NE candidate classes in the NE extraction results. By way of example, the creation module 14c counts the number of times which the NE candidate class concerning “YAMADA” is outputted as the “person's name” or the “place”, in all the NE extraction results, and it counts the number of times of appearance which the NE candidate class located one word (w+1) after the current position (w0) being the position of “YAMADA” is outputted as the “another” (refer to FIG. 2).

After having counted the frequencies of appearance, the lexicon information creation module 14c determines the ranking of the NE candidate classes corresponding to the frequencies of appearance. In a case, for example, where the frequency of appearance at which the NE candidate class is outputted as the “person's name” as to “YAMADA” is “255” and where the frequency of appearance at which it is outputted as the “place” is “13”, the “person's name” is determined to be in the rank “1” (first rank), and the “place” is determined to be in the rank “2” (second rank) (refer to FIG. 2). Incidentally, since only one NE candidate class located one word after “YAMADA” is extracted (only the “another” is extracted), the “another” is determined to be in the rank “1” (refer to FIG. 2).

In addition, the lexicon information creation module 14c confirms whether or not the processing thus far described (the extraction of the NE candidate classes, the counting of the frequencies of appearance, and the determination of the ranks) has been executed as to all the words extracted from the NE extraction results. In a case where all the words have been processed as the result of the confirmation, the processing is ended. On the other hand, in a case where all the extracted words have not been processed as stated above, the processing is executed from the extraction of the NE candidate classes in succession for the respective remaining words. In a case, for example, where “YAMADA” has been processed, the processing is subsequently executed from the extraction of the NE candidate classes as to “SAN” (refer to FIG. 2).

Incidentally, the named entity extraction apparatus 10 according to Embodiment 1 can also be configured in such a way that the respective functions stated above are installed in a known information processor such as a personal computer or workstation.

(Process of Named Entity Extraction Apparatus (Embodiment 1))

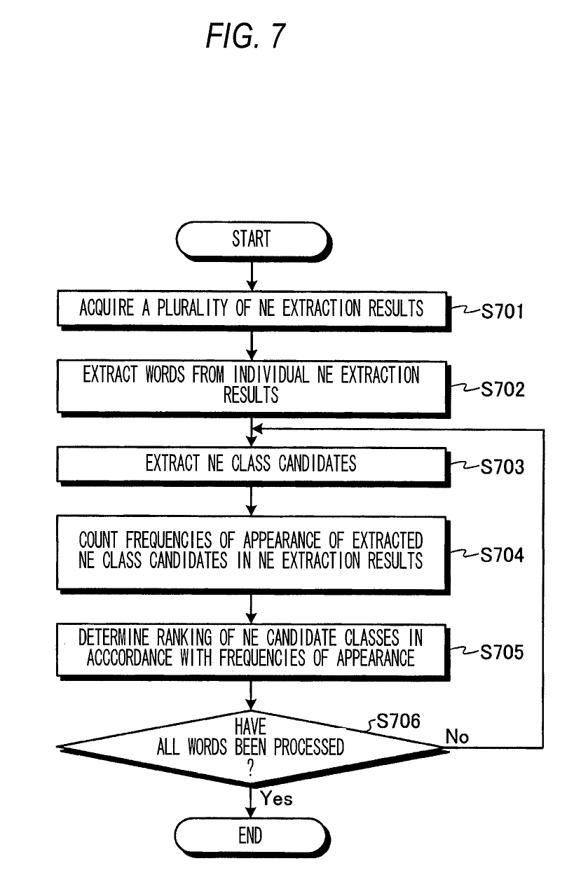

Subsequently, the process of the named entity extraction apparatus according to Embodiment 1 will be described with reference to FIG. 7. FIG. 7 is a flow chart showing the flow of the process of the named entity extraction apparatus according to Embodiment 1.

As shown in the figure, when the lexicon information creation module 14c acquires a plurality of NE extraction results from the NE extraction process execution module 14b (step S701), it automatically creates lexicon information which serves to obtain clues for extracting named entities from text data. First, the lexicon information creation module 14c extracts words (for example, words “YAMADA” and “SAN”) from the plurality of NE extraction results without being repeated (step S702). In addition, the lexicon information creation module 14c executes processing to be described below, in a sequence from, for example, the first extracted word.

First, the lexicon information creation module 14c checks the individual NE extraction results in succession, so as to extract NE candidate classes (step S703). Concretely, the individual NE extraction results are checked in succession, so as to extract the NE candidate class for, for example, the word extracted first from the individual NE extraction results and to extract the NE candidate classes located before and after the first extracted word as a current position.

By way of example, the lexicon information creation module 14c extracts the NE candidate class (for example, a “person's name” or a “place”) as to “YAMADA” which is the word extracted from the NE extraction results, and it extracts the NE candidate class (for example, “another”) which is located one word (w+1) after the current position (w0) being the position of “YAMADA” (refer to FIG. 2).

After having extracted the NE candidate classes, the lexicon information creation module 14c counts the frequencies of appearance of the NE candidate classes in the NE extraction results (step S704). By way of example, the creation module 14c counts the number of times which the NE candidate class concerning “YAMADA” is outputted as the “person's name” or the “place”, in all the NE extraction results, and it counts the number of times of appearance which the NE candidate class located one word (w+1) after the current position (w0) being the position of “YAMADA” is outputted as the “another” (refer to FIG. 2).

After having counted the frequencies of appearance, the lexicon information creation module 14c determines the ranking of the NE candidate classes corresponding to the frequencies of appearance (step S705). In a case, for example, where the frequency of appearance at which the NE candidate class is outputted as the “person's name” as to “YAMADA” is “255” and where the frequency of appearance at which it is outputted as the “place” is “13”, the “person's name” is determined to be in the rank “1” (first rank), and the “place” is determined to be in the rank “2” (second rank) (refer to FIG. 2). Incidentally, since only one NE candidate class located one word after “YAMADA” is extracted (only the “another” is extracted), the “another” is determined to be in the rank “1” (refer to FIG. 2).

In addition, the lexicon information creation module 14c confirms whether or not the processing thus far described (the extraction of the NE candidate classes, the counting of the frequencies of appearance, and the determination of the ranks) has been executed as to all the words extracted from the NE extraction results (step S706). In a case where all the words have been processed as the result of the confirmation (the affirmation of the step S706), the processing is ended. On the other hand, in a case where all the extracted words have not been processed as stated above (the negation of the step S706), the processing is executed from the extraction of the NE candidate classes in succession for the respective remaining words. By way of example, after “YAMADA” has been processed, the processing is executed from the extraction of the NE candidate classes as to “SAN” (refer to FIG. 2).

In this manner, according to Embodiment 1, it is possible to easily create a lexicon which serves to obtain the clues for extracting the named entities from the text data, without expending much labor.

It is also possible to create detailed and beneficial lexicon information of high reliability.

Further, Embodiment 1 has been described concerning the case where the lexicon information is automatically created using all the information items acquired from the plurality of NE extraction results, but the invention is not restricted to such an aspect. The information items (the NE candidate classes, the frequencies of appearance, and the ranks) obtained from the individual NE extraction results may well be adopted as the lexicon information in accordance with the degrees of coincidence (for example, the degree of coincidence of 100%, and the degree of coincidence of 80%) of the respective NE extraction results outputted from a plurality of NE extractors, in such a manner that, in a case where all the NE classification candidates for the word “YAMADA” is the “person's name” by way of example, the NE candidate class “person's name” is determined to be adopted as the lexicon information.

Still further, each time the NE extraction process is executed for one text data, whether or not information items obtained from the individual NE extraction results are adopted as information items for creating the lexicon information may well be determined (the adoptions or rejections of the information items). That is, whether or not the information items (the NE candidate classes, the frequencies of appearance, and the ranks) obtained from the individual NE extraction results are adopted as information items for creating the lexicon information may well be determined in accordance with the degrees of coincidence (for example, the degree of coincidence of 100%, and the degree of coincidence of 80%) of the NE extraction results for a word having appeared in certain places within the text data, in such a manner that, in a case where the NE extraction results for the word “YAMADA” having appeared in the certain places within the text data are the same in all the NE extractors, the same NE extraction result is adopted as the information for creating the lexicon information.

In this way, lexicon information of higher reliability can be created as the lexicon information which is utilized as the clues in extracting the named entities from the text data.

Embodiment 1 has been described concerning the case where the lexicon information is automatically created using the plurality of NE extraction results. However, the invention is not restricted to the aspect, but an NE extraction model for extracting named entities from text data may well be created anew by using the lexicon information created automatically.

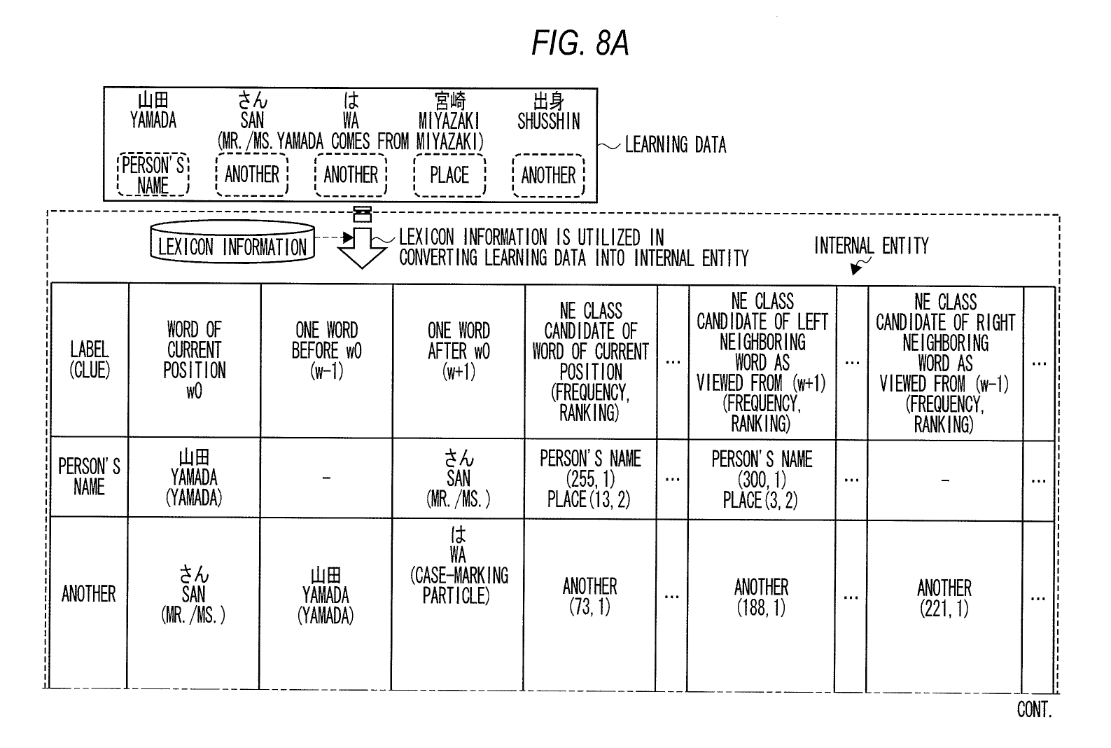

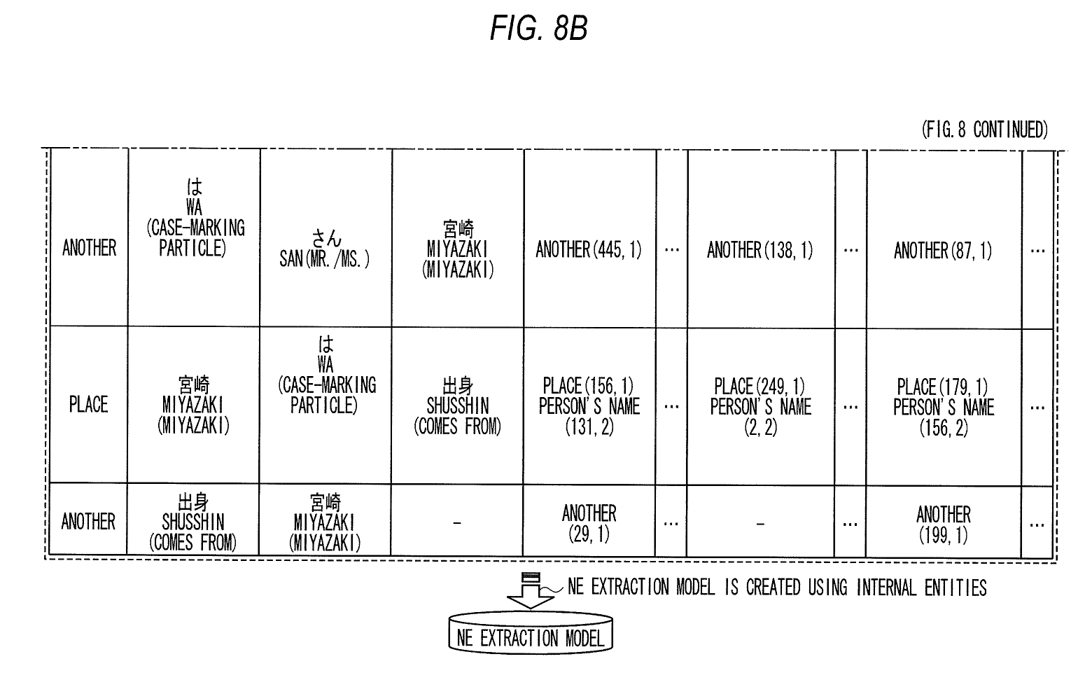

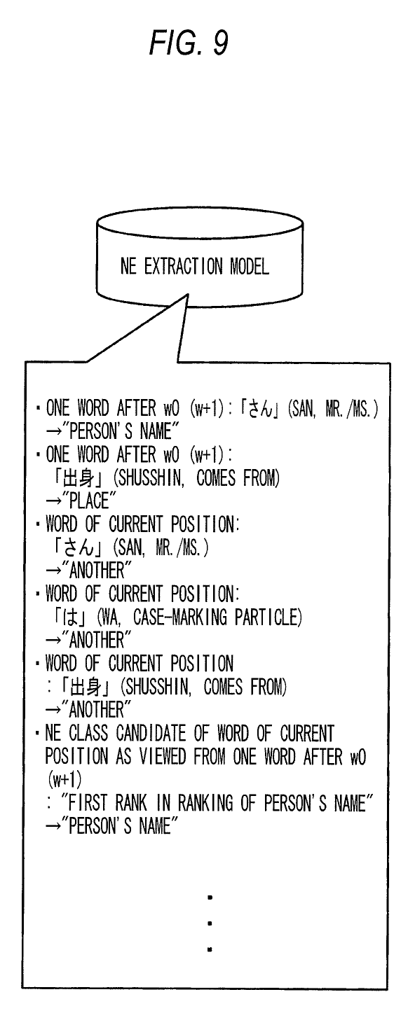

In this regard, the outline and features of a named entity extraction apparatus according to Embodiment 2 will be described below with reference to FIGS. 8 and 9, and an advantage based on Embodiment 2 will be described. FIG. 8 is a diagram for explaining the outline and features of the named entity extraction apparatus according to Embodiment 2, while FIG. 9 is a diagram showing a structural example of an NE extraction model according to Embodiment 2.

The named entity extraction apparatus according to Embodiment 2 is outlined as creating the NE extraction model for extracting the named entities from the text data, and it has its feature in the point that the NE extraction model is created anew by using the lexicon information created automatically.

More specifically, the NE extractor creation module 14a (refer to FIG. 3) of the named entity extraction apparatus converts learning data which is exemplary data with correct interpretation, into an internal entity corresponding to a position within the data, as shown in FIG. 8. On that occasion, information obtained from the lexicon information is added to the internal entity by utilizing the lexicon information created by the lexicon information creation module 14c.

By way of example, the information item of the NE candidate class of a word at a current position and the information items of the NE candidate classes of the word at the current position as viewed from words located before and after the word at the current position are added, and information items on the frequency of appearance and the rank are added in association with the individual NE candidate classes.

In addition, the NE extractor creation module 14a analyzes the internal entity to which the information items obtained from the lexicon information have been added, by applying this internal entity to a machine learning algorithm, whereby the NE extraction model (rules) for extracting the NEs from the text data is created anew. Besides, the NE extractor creation module 14a creates an NE extractor which operates the new NE extraction model created. As shown in FIG. 9, a plurality of NE extraction models are found out on the basis of the machine learning algorithm, from the internal entity to which the information items obtained from the lexicon information have been added.

Besides, the NE extraction process execution module 14b (refer to FIG. 3) of the named entity extraction apparatus executes the NE extraction process for the inputted text data by employing the NE extractor which operates the NE extraction models created anew by the NE extractor creation module 14a.

According to Embodiment 2, clues of higher reliability can be obtained in the case of extracting the named entities from the text data, with the result that the named entities can be precisely extracted from the text data.

Although Embodiments 1 and 2 of the invention have thus far been described, the invention may well be performed in various different aspects otherwise than the foregoing embodiments. Therefore, other embodiments covered within the invention will be described below.

(1) Apparatus Configuration, Etc.

The individual constituents of the named entity extraction apparatus 10 shown in FIG. 3 are of functional concepts, and the extraction apparatus need not always be physically configured as shown in the figure. More specifically, the practicable aspects of the decentralization and integration of the named entity extraction apparatus 10 are not limited to the illustrated ones, but some or all of the constituents can be decentralized or integrated functionally or physically in arbitrary units in accordance with various loads, the situation of use, etc., in such a manner that the lexicon information creation module 14c is decentralized into an NE classification candidate extraction function, a frequency-of-appearance counting function and an NE classification candidate ranking function. Further, all or any desired one of the individual processing functions which are executed by the named entity extraction apparatus 10 can be implemented in a CPU and programs/a program which are/is analyzed and run by the CPU, or it can be configured as hardware which is based on wired logic.

(2) Named Entity Extraction Program

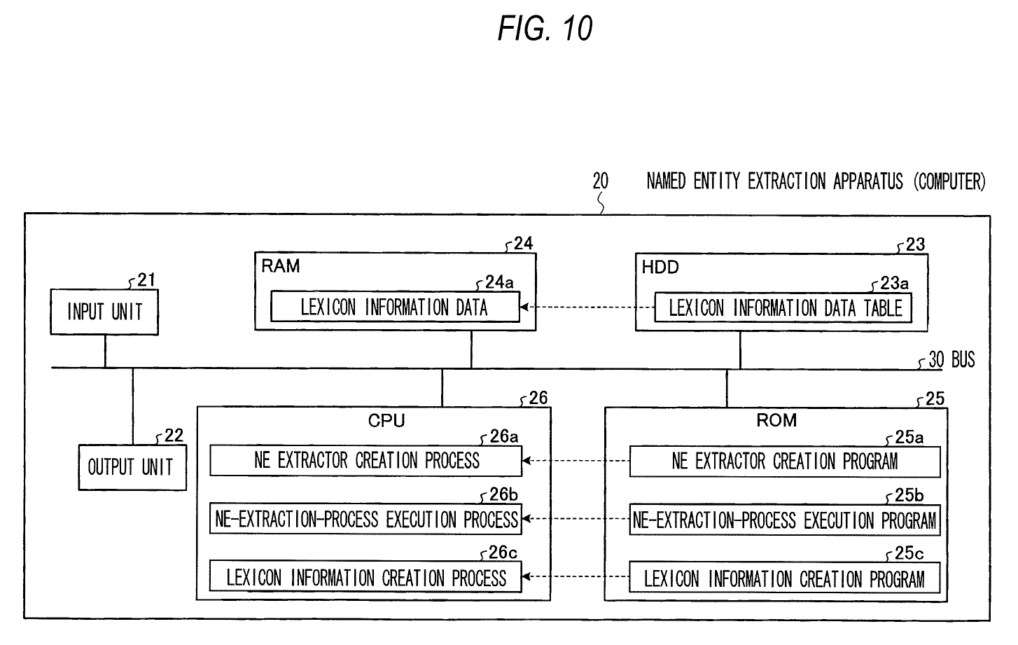

Meanwhile, the various processes (refer to FIG. 7, etc.) described in Embodiment 1 or Embodiment 2 can be incarnated in such a way that programs prepared beforehand are run by a computer system such as a personal computer or workstation. In this regard, an example of a computer which runs a named entity extraction program having the same functions as those of Embodiment 1 or Embodiment 2 will be described with reference to FIG. 10 below. FIG. 10 is a diagram showing the computer which runs the named entity extraction program.

As shown in the figure, the computer 20 is configured as the named entity extraction apparatus by connecting an input unit 21, an output unit 22, an HDD 23, a RAM 24, a ROM 25 and a CPU 26 through a bus 30. Incidentally, the input unit 21 and the output unit 22 correspond to the input unit 11 and the output unit 12 of the named entity extraction apparatus 10 shown in FIG. 3, respectively.

In addition, the named entity extraction program which demonstrates the same functions as those of the named entity extraction apparatus shown in Embodiment 1, that is, an NE extractor creation program 25a, an NE-extraction-process execution program 25b and a lexicon information creation program 25c is/are stored in the ROM 25 beforehand as shown in FIG. 10. Incidentally, the programs 25a, 25b and 25c may well be appropriately integrated or decentralized likewise to the individual constituents of the named entity extraction apparatus 10 shown in FIG. 3. By the way, the ROM 25 may well be replaced with a nonvolatile “RAM”.

Further, the CPU 26 reads out the programs 25a, 25b and 25c from the ROM 25 and runs them, whereby the respective programs 25a, 25b and 25c function as an NE extractor creation process 26a, an NE-extraction-process execution process 26b and a lexicon information creation process 26c as shown in FIG. 10. Incidentally, the respective processes 26a, 26b and 26c correspond to the NE extractor creation module 14a, NE extraction process execution module 14b and lexicon information creation module 14c of the named entity extraction apparatus 10 shown in FIG. 3, respectively.

Besides, the HDD 23 is provided with a lexicon information data table 23a as shown in FIG. 10. Incidentally, the lexicon information data table 23a corresponds to the lexicon information storage module 13a shown in FIG. 3. In addition, the CPU 26 reads out lexicon information data 24a from the lexicon information data table 23a and stores them in the RAM 24, and it executes the processes on the basis of the lexicon information data 24a stored in the RAM 24.

Incidentally, the individual programs 25a, 25b and 25c need not always be stored in the ROM 25 from the beginning. By way of example, it is also allowed that the programs are previously stored in a “portable physical medium” such as flexible disk (FD), CD-ROM, DVD, magnetooptical disk or IC card which is inserted into the computer 20, a “fixed physical medium” such as HDD which is disposed inside or outside the computer 20, or “another computer (or server)” which is connected to the computer 20 through a public network, the Internet, a LAN, a WAN or the like, and that the computer 20 reads out the programs from such storage means and runs them.

According to the invention, a lexicon which serves to obtain clues for extracting named entities from text data can be easily created without expending much labor. Besides, the alteration of the pattern of the text data can be coped with according to the circumstances, in such a manner that, in a case where the pattern (for example, language or context) of the text data supposed to be inputted has been altered, lexicon information is immediately renewed to create a new lexicon.

Besides, lexicon information of high reliability can be created as clues in extracting named entities from text data.

Further, detailed and beneficial information can be obtained as clues in extracting named entities from text data.

Still further, lexicon information of higher reliability can be created as lexicon information which is utilized as clues in extracting named entities from text data.

Yet further, clues of higher reliability can be obtained in case of extracting named entities from text data, with the result that the named entities can be precisely extracted from the text data.

What is claimed is:

1. A computer-readable record medium in which a named entity extraction program to be executed by a computer is stored, the named entity extraction program comprising:
an extraction result acquisition procedure for acquiring a named entity extraction result obtained as a result of a named entity extraction process; and
a lexicon information creation procedure for creating lexicon information which is utilized as clues in extracting named entities from text data, on the basis of the named entity extraction result acquired by said extraction result acquisition procedure.

2. A computer-readable record medium as defined in claim 1, wherein said extraction result acquisition procedure executes the named entity extraction process by using a plurality of named entity extraction models for extracting the named entities from the text data, thereby to acquire a plurality of named entity extraction results obtained as the result of the named entity extraction process.

3. A computer-readable record medium as defined in claim 1, wherein said lexicon information creation procedure creates the lexicon information which contains class candidate information indicating a class candidate as the named entity, frequency-of-appearance information indicating a frequency of appearance of the class candidate in the whole named entity extraction result, and rank information indicating a rank of the class candidate information as corresponds to the frequency-of-appearance information, for each word contained in the text data and other words appearing before and after the certain word, on the basis of the named entity extraction result acquired by said extraction result acquisition procedure.

4. A computer-readable record medium as defined in claim 3, wherein said lexicon information creation procedure determines whether or not the class candidate information, the frequency-of-appearance information and the rank information are adopted in accordance with degrees of coincidence of the named entity extraction result acquired by said extraction result acquisition procedure, and it creates a lexicon which contains class candidate information, frequency-of-appearance information and rank information that have been determined to be adopted.

5. A computer-readable record medium as defined in claim 1, further comprising:
a model creation procedure for creating a named entity extraction model for extracting the named entities from the text data, anew by using the lexicon information created by said lexicon information creation procedure.

6. A named entity extraction method comprising:
an extraction result acquisition step of acquiring a named entity extraction result obtained as a result of a named entity extraction process; and
a lexicon information creation step of creating lexicon information which is utilized as clues in extracting named entities from text data, on the basis of the named entity extraction result acquired by said extraction result acquisition step.

7. A named entity extraction method as defined in claim 6, wherein said extraction result acquisition step executes the named entity extraction process by using a plurality of named entity extraction models for extracting the named entities from the text data, thereby to acquire a plurality of named entity extraction results obtained as the result of the named entity extraction process.

8. A named entity extraction method as defined in claim 6, wherein said lexicon information creation step creates the lexicon information which contains class candidate information indicating a class candidate as the named entity, frequency-of-appearance information indicating a frequency of appearance of the class candidate in the whole named entity extraction result, and rank information indicating a rank of the class candidate information as corresponds to the frequency-of-appearance information, for each of a certain word contained in the text data and other words appearing before and after the certain word, on the basis of the named entity extraction result acquired by said extraction result acquisition step.

9. A named entity extraction method as defined in claim 8, wherein said lexicon information creation step determines whether or not the class candidate information, the frequency-of-appearance information and the rank information are adopted in accordance with degrees of coincidence of the named entity extraction result acquired by said extraction result acquisition step, and the lexicon information creation step creates a lexicon which contains class candidate information, frequency-of-appearance information and rank information that have been determined to be adopted.

10. A named entity extraction method as defined in claim 6, further comprising:
a model creation step of creating a named entity extraction model for extracting the named entities from the text data, anew by using the lexicon information created by said lexicon information creation step.

11. A named entity extraction apparatus comprising:
an extraction result acquisition unit for acquiring a named entity extraction result obtained as a result of a named entity extraction process; and
a lexicon information creation unit for creating lexicon information which is utilized as clues in extracting named entities from text data, on the basis of the named entity extraction result acquired by said extraction result acquisition unit.

12. A named entity extraction apparatus as defined in claim 11, wherein said extraction result acquisition unit executes the named entity extraction process by using a plurality of named entity extraction models for extracting the named entities from the text data, thereby to acquire a plurality of named entity extraction results obtained as the result of the named entity extraction process.

13. A named entity extraction apparatus as defined in claim 11, wherein said lexicon information creation unit creates the lexicon information which contains class candidate information indicating a class candidate as the named entity, frequency-of-appearance information indicating a frequency of appearance of the class candidate in the whole named entity extraction result, and rank information indicating a rank of the class candidate information as corresponds to the frequency-of-appearance information, for each of a certain word contained in the text data and other words appearing before and after the certain word, on the basis of the named entity extraction result acquired by said extraction result acquisition unit.

14. A named entity extraction apparatus as defined in claim 13, wherein said lexicon information creation unit determines whether or not the class candidate information, the frequency-of-appearance information and the rank information are adopted in accordance with degrees of coincidence of the named entity extraction result acquired by said extraction result acquisition unit, and said lexicon information creation unit creates a lexicon which contains class candidate information, frequency-of-appearance information and rank information that have been determined to be adopted.

15. A named entity extraction apparatus as defined in claim 11, further comprising:
a model creation unit for creating a named entity extraction model for extracting the named entities from the text data, anew by using the lexicon information created by said lexicon information creation unit.
